(19) United States
(12) Patent Application Publication
(10) Pub. No.: US 2004/0115110 A1
(43) Pub. Date: Jun. 17, 2004

(54) Method and device for reducing nitrogen oxides present in exhaust gas

(76) Inventors: Wolfgang Ripper, Stuttgart (DE); Gerd Scheying, Stuttgart (DE); Johannes Schaller, Leonberg (DE)

Correspondence Address: KENYON & KENYON, ONE BROADWAY, NEW YORK, NY, 10004, US

(21) Appl. No.: 10/250,856

(22) PCT Filed: Oct. 18, 2002
(86) PCT No.: PCT/DE02/03947

(30) Foreign Application Priority Data
Nov. 6, 2001 (DE) 101 54 421.9

(51) Int. Cl. B01D 53/56

(52) U.S. Cl. 423/235; 422/172; 422/177; 422/173

(57) ABSTRACT

A method of reducing nitrogen oxides of an exhaust gas, of an exhaust gas of a motor vehicle in particular, is described, an aqueous urea solution being fed to a reactor (42) and converted by thermal, catalytic or enzymatic treatment into a decomposition product containing ammonia and carbon dioxide and at least the ammonia is added to the exhaust gas. The aqueous urea solution contains a substance for transferring heat and for lowering the freezing point (FIG. 7).

### BACKGROUND INFORMATION

The present invention is directed to a method of reducing nitrogen oxides in an exhaust gas, an exhaust gas of a motor vehicle in particular, according to the species defined in greater detail in the preamble of Claim 1, and to a device for implementing the method according to the species defined in greater detail in the preamble of Claim 15.

In diesel engines in particular, it has proven successful to add urea in aqueous solution to the exhaust gas generated by the internal combustion engine. In known methods for doing this, a hydrolytic catalytic converter is used in which ammonia is obtained from the urea. The aqueous urea solution is atomized into the exhaust system in question upstream of the hydrolytic catalytic converter. In an SCR catalytic converter, the ammonia then reacts with the nitrogen oxides contained in the exhaust gas to form molecular nitrogen and water.

When the aqueous urea solution is injected into the exhaust gas, compressed air may be used additionally to promote atomization of the solution so that an aerosol is formed. Droplets of the aqueous urea solution are thus distributed in the exhaust gas.

The use of compressed air further reduces the danger of the urea crystallizing out of the aqueous urea solution and plugging the nozzle or a line leading to the nozzle.

In systems that operate without additional compressed air, it has been shown that it is not possible to reliably ensure that the urea crystallizes out of the aqueous urea solution.

In a method known from practical operation to reduce nitrogen oxides in an exhaust gas of a motor vehicle, a 32.5% urea solution is supplied in a tank. This solution is withdrawn from the tank and introduced into the exhaust gas for removing the nitrogen oxides from the exhaust gas. The droplets of the urea solution that are produced when the atomized solution is introduced are heated in the exhaust gas so that the water evaporates from the solution and the urea dries. This causes the urea to crystallize. The urea crystals produced in this manner are further heated until the melting point of the urea is reached at 130° C. At this temperature, the urea is thermally decomposed into ammonia (NH₃) and isocyanic acid (HNCO). By using a hydrolytic catalytic converter, the isocyanic acid is converted by water into ammonia and carbon dioxide.

Under non-ideal operating conditions in particular, crystals or undesirable byproducts may be produced in the method described above. Such byproducts are, for example, water-insoluble biuret, which is formed from isocyanic acid and urea, and cyanuric acid, which represents the trimerization product of isocyanic acid.

A method of the type mentioned above is known from U.S. Pat. No. 6,077,491. In this method, solid urea is fed to a tank from a storage bin and is processed with water there to form an aqueous urea solution. A pump feeds the aqueous urea solution to a hydrolytic reactor where it is heated by a heating apparatus and thus preconditioned. During the heating, ammonium carbonate is produced as a byproduct from which ammonia and carbon dioxide are produced, which are for the most part present in a gaseous phase. The gaseous phase is then fed to a process gas stream via a check valve with the support of compressed air, as a result of which nitrogen oxides contained in it are broken down.

### Advantages of the Invention

The method of reducing nitrogen oxides in an exhaust gas, an exhaust gas of a motor vehicle in particular, having the features according to the preamble of Claim 1, in which method the aqueous urea solution includes a substance for transferring heat and for lowering the freezing point, has the advantage when used in motor vehicles in particular that it is also usable at low ambient temperatures.

The use of the method of the present invention in which the aqueous urea solution including the substance for transferring heat and for lowering the freezing point is preconditioned makes it possible to ensure an extensive reduction of nitrogen oxides in an exhaust gas down to temperatures of minus 40° C. without the formation of urea crystals which might clog lines or nozzles of a device for implementing the method.

The substance for transferring heat and for lowering the freezing point is basically distinguished here by the fact that it does not react chemically with urea, has a boiling point higher than that of water and has a freezing point lower than that of water. In the event of an excess of ammonia and carbon dioxide contained in the aqueous solution, the substance is also preferably used to stabilize the solution.

The substance for transferring heat and for lowering the freezing point and H₂O constitutes the carrier for the urea contained in the solution.

The substance for transferring heat and for lowering the freezing point is selected, for example, from a group including diethylene glycol diethyl ether, diethylene glycol dibutyl ether, diethylene triamine, diethyl glycol and glycerin.

According to a preferred embodiment of the method of the present invention, the aqueous urea solution including the substance for transferring heat and for lowering the freezing point is a supersaturated solution, the urea and the water of the solution having a 1:1 molar ratio. As a result, it is possible in the ideal case to completely hydrolyze the urea in the preconditioning in the reactor, no additional water vapor being withdrawn from the reactor.

The thermohydrolysis of the urea proceeds according to the following formula:

(NH₂)₂CO+H₂0→2NH₃+CO₂

According to a preferred embodiment of the method of the present invention, the aqueous urea solution including the substance for transferring heat and for lowering the freezing point is pumped into the reactor under pressure. All liquid constituents of the solution and the gases dissolved in the solution constitute the carrier for the urea in this case. In this high-pressure method, the aqueous urea solution is preferably heated to a temperature higher than approximately 180° C. Under these conditions, the urea is completely broken down into ammonia and carbon dioxide in the aqueous solution. No undesirable byproducts such as isocyanic acid are produced. The decomposition product, including the ammonia and the carbon dioxide, may be introduced directly in the atomized state, and thus added to the exhaust gas in question.

To separate a gaseous phase and a liquid phase, the gaseous phase including carbon dioxide, ammonia and H₂O if necessary, the pressure of the decomposition product is advantageously relieved downstream of the reactor. However, the pressure of the gaseous phase present after the pressure relief should be higher than the pressure of the exhaust gas in question, making it possible to feed the gaseous phase to the exhaust gas without a further expenditure of energy.

As an alternative, in a low-pressure method in which the aqueous urea solution is fed to the reactor under atmospheric pressure, for example, the decomposition product is compressed downstream of the reactor, also to a pressure that is higher than the pressure of the exhaust gas in question.

In the low-pressure method, it may possibly be adequate to heat the aqueous urea solution including the substance for transferring heat and for lowering the freezing point to a temperature between 80° C. and 150° C. The thermolysis, i.e., the thermal decomposition of urea into ammonia and isocyanic acid takes place at these temperatures. The constituents remain in aqueous solution, which prevents the formation of undesirable byproducts. The aqueous solution may then be atomized into the exhaust gas and heated further by the exhaust gas. In aqueous solution, the undesirable isocyanic acid decomposes in reaction with water to form carbon dioxide and ammonia.

If the decomposition product includes a liquid and a gaseous phase, the liquid phase may be returned to a tank for the aqueous urea solution including the substance for transferring heat and for lowering the freezing point. As a rule, the liquid phase includes water, the substance, and small quantities of dissolved ammonia and carbon dioxide.

Advantageously, the pressure of the liquid phase is relieved when it is returned to the tank, specifically to the pressure existing in the tank, to atmospheric pressure, for example.

Occasionally, it may be advantageous to cool the aqueous urea solution preconditioned in the reactor downstream of the reactor. If a metering valve is present, this should also take place upstream of the metering valve to protect it from thermal damage.

An economical process control is ensured if the aqueous urea solution including the carrier is heated by the exhaust gas. In this case, the reactor is, for example, situated in an exhaust system of a motor vehicle so that the exhaust gas heats the reactor and accordingly the urea solution including the substance for transferring heat and for lowering the freezing point.

A further object of the invention is a device for implementing such a method according to the present invention. This device includes a tank for an aqueous urea solution, a reactor in which the aqueous urea solution is preconditioned and a valve used to feed a decomposition product including ammonia produced by the reactor to an exhaust system. The aqueous urea solution includes a substance for transferring heat and for lowering the freezing point.

The device of the present invention is suited in particular for use in an exhaust system of a diesel engine of a motor vehicle.

Additional advantages and advantageous embodiments of the object of the present invention may be found in the description, the drawing and the claims.

### DRAWING

Several exemplary embodiments of the method of the present invention and the device of the present invention are shown schematically in a simplified form in the drawing and are explained in greater detail in the following description.

FIG. 1 shows a schematic diagram of a low-pressure method of reducing nitrogen oxides in an exhaust gas;

FIG. 2 shows a schematic diagram of a device for implementing the method according to FIG. 1;

FIG. 3 shows a high-pressure method of reducing nitrogen oxides in an exhaust gas;

FIG. 4 shows a schematic diagram of a device for implementing the method according to FIG. 3;

FIG. 5 shows a schematic diagram of an alternative device for implementing the method according to FIG. 3;

FIG. 6 shows a schematic diagram of a special embodiment of a device for implementing a high-pressure method of reducing nitrogen oxides in an exhaust gas of a motor vehicle, and

FIG. 7 shows a special embodiment of a high-pressure method of reducing nitrogen oxides in an exhaust gas of a motor vehicle.

### DESCRIPTION OF THE EXEMPLARY EMBODIMENTS

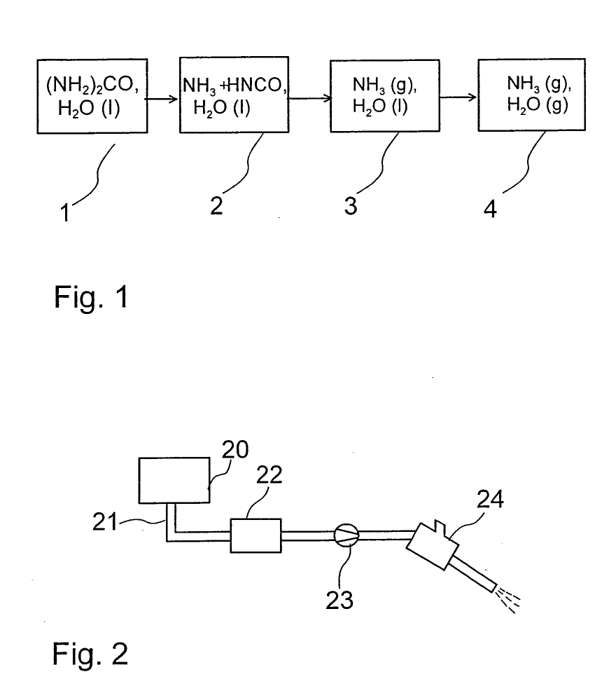

A low-pressure method of preconditioning an aqueous urea solution is shown in FIG. 1, the aqueous urea solution including a substance for transferring heat and for lowering the freezing point. It is possible to implement the method according to FIG. 1 using a device shown in FIG. 2.

In the method according to FIG. 1, an aqueous, for example, 32.5% urea solution including a substance for transferring heat and for lowering the freezing point is stored in a tank 20 in a step 1. This substance is made up of diethylene glycol diethyl ether, for example.

In a step 2, the solution carried in tank 20 is fed into a reactor 22 via a line 21 and heated there to a temperature between 80° C. and 150° C.

The urea (NH₂)₂CO contained in the solution is decomposed by the heating of the solution into ammonia NH₃ and isocyanic acid HNCO and is thus preconditioned. HNCO is unstable in aqueous solution and breaks down into NH₃ and CO₂. Consequently, the decomposition product or preconditioning product is made up of ammonia, water, CO₂ and the substance for transferring heat and for lowering the freezing point, it being possible for the ammonia to be partially present in gaseous form as a function of the process pressure.

In a further step 3, the decomposition product described above is introduced into an exhaust system of a motor vehicle (not shown) using a pump 23 and a solenoid valve 24 and is there heated further in a step 4 so that the water evaporates and is consequently converted into a gaseous state. The gaseous ammonia NH₃ reacts with nitrogen oxides contained in the exhaust gases flowing in the exhaust system, forming molecular nitrogen and water. The reaction takes place in a selective catalytic reduction (SCR) catalytic converter.

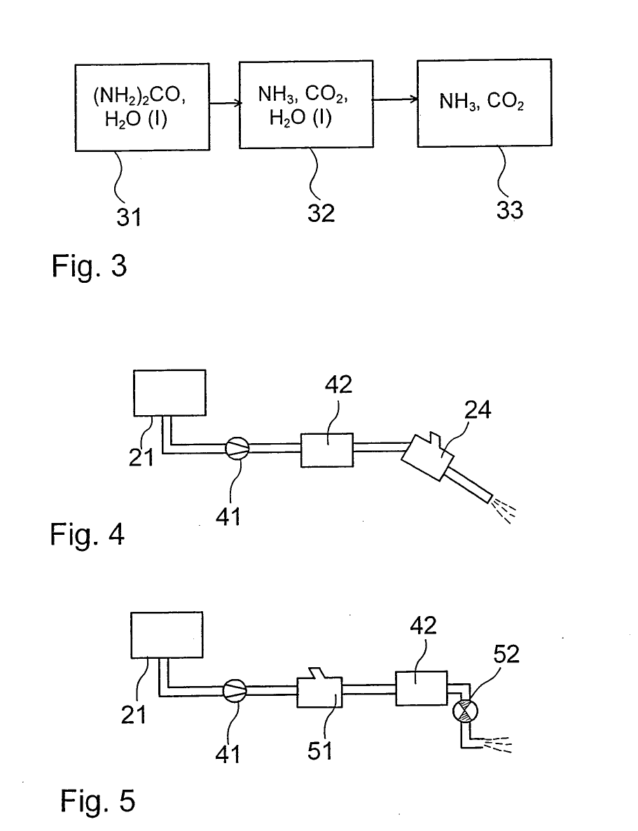

A high-pressure method of reducing nitrogen oxides in an exhaust gas of a motor vehicle is shown in FIG. 3. A device for implementing the method is shown in FIG. 4 and FIG. 5.

As in the low-pressure method, in the high-pressure method shown in FIG. 3, a supersaturated aqueous urea solution is produced having a 1:1 molar ratio of urea to water, which includes diethylene glycol diethyl ether as a substance for transferring heat and for lowering the freezing point. In the high-pressure method, however, in a second step 32, this solution is fed under pressure to a reactor 42 and is heated there to a temperature of at least 180° C., for example, 220° C., so that the urea in the aqueous solution is converted into ammonia NH₃ and carbon dioxide CO₂. The conversion or decomposition is complete.

In a third step 33, the decomposition product or the gaseous phase of the decomposition product made up of ammonia NH₃ and carbon dioxide CO₂ is introduced via a solenoid valve 24 into an exhaust system of a motor vehicle having a diesel engine. There the ammonia reacts with the nitrogen oxides contained in the exhaust gas in a SCR catalytic converter to form molecular nitrogen and water. The SCR catalytic converter is made up, for example of layered zeolites or copper exchanged zeolites.

An alternative embodiment of a device for implementing the method according to FIG. 3 is shown in FIG. 5. This device differs from the one according to FIG. 4 in that a solenoid valve 51, via which the feed of the aqueous urea solution including the substance for transferring heat and for lowering the freezing point into reactor 20 is controlled, is situated between pump 41 and reactor 42. Furthermore, a check valve 52 instead of a solenoid valve is situated downstream of reactor 42, the check valve opening as soon as the gas pressure generated in reactor 42 exceeds the pressure of the exhaust gas present in the exhaust system by a specific amount, for example, 1 bar.

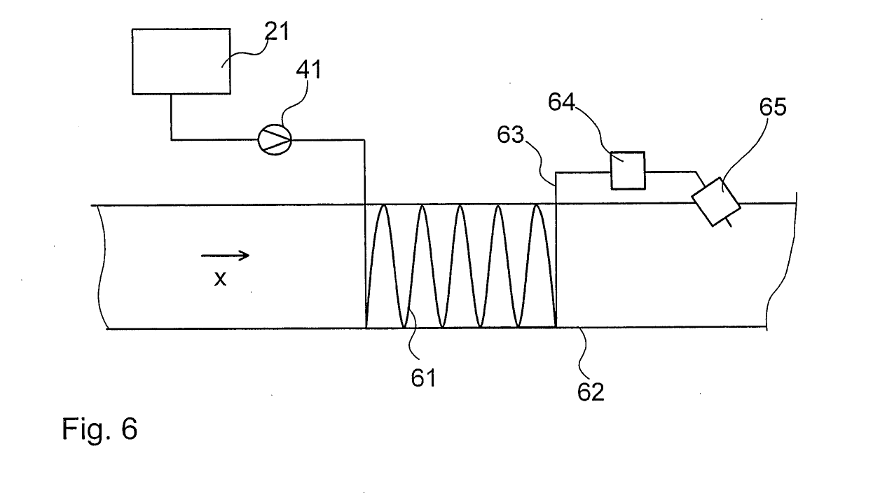

A special embodiment for implementing the method according to FIG. 3 is shown in FIG. 6. This device includes a tank 21 for an aqueous urea solution including a substance for transferring heat and for lowering the freezing point, it also being possible to use the tank to stabilize the solution. A pump 41 is connected downstream of tank 21, via which the aqueous urea solution including the substance is conveyed into a helical reactor 61.

Reactor 61 is situated in an exhaust system 62 of a motor vehicle having a diesel engine. The direction of flow of an exhaust gas in exhaust system 62 is indicated by an arrow x. Using the exhaust gas, it is thus possible to heat the urea solution including the substance for transferring heat and for lowering the freezing point to a temperature higher than 180° C., ideally to 220° C. As a result, the urea contained in the solution is broken down to ammonia and CO₂.

Downstream of reactor 61, a line 63 leads out of exhaust system 62 to a heat exchanger 64. The decomposition product heated in reactor 61 designed as a helical pipe is cooled in heat exchanger 64 so that a downstream metering valve 65 again leading into exhaust system 62 is protected against thermal damage.

A SCR catalytic converter (not shown) is located in the exhaust system downstream of metering valve 65, the ammonia introduced via metering valve 65 reacting in the SCR catalytic converter with the nitrogen oxides contained in the exhaust gas to form nitrogen and water.

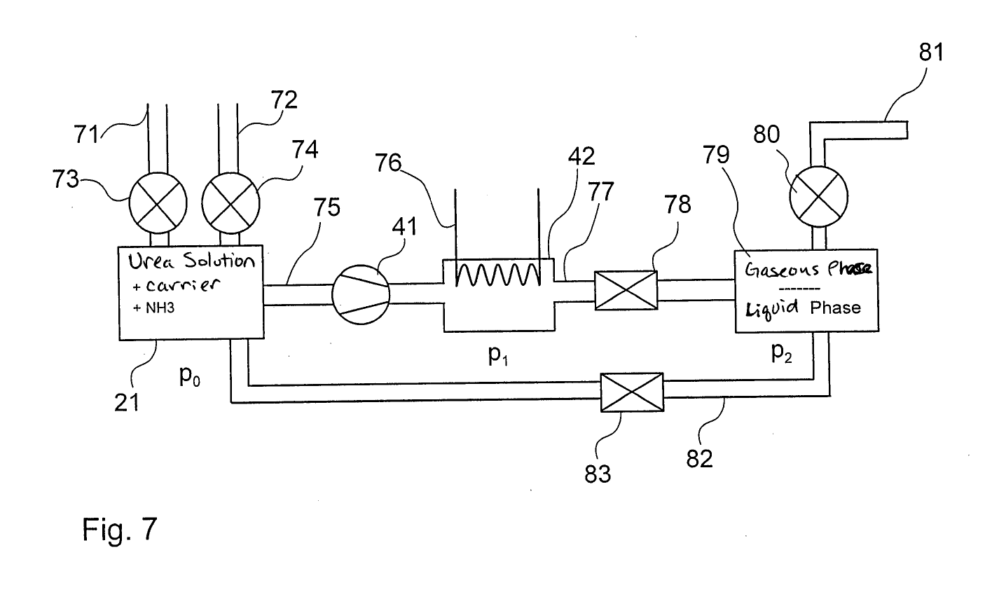

Another embodiment of a method of the present invention is shown in FIG. 7 using a schematically suggested device for metering ammonia into an exhaust system (not shown) of a motor vehicle having a diesel engine.

The device shown in FIG. 7 includes a tank 21 for an aqueous solution, which includes urea and diethylene glycol dibutyl ether as a substance for transferring heat and for lowering the freezing point. The solution is under a pressure p₀ in tank 21 and represents a saturated solution, which has the advantage that the concentration of urea in the solution is always constant.

For filling, tank 21 is equipped with a first feed line 71 to feed solid urea and a second feed line 72 to feed water and the substance for transferring heat and for lowering the freezing point. Feed line 71 is provided with a stop valve 73 and feed line 72 is provided with a stop valve 74.

Via a line 75, in which a pump 41 is situated, tank 21 is connected to a reactor 42, in which a heating element 76 is situated. Downstream, reactor 42 is connected to a line 77, in which a throttle valve 78 is arranged which leads to a reservoir 79. Reservoir 79 is connected to a metering pipe 81 via a metering valve 80, the metering pipe leading into the exhaust system of the motor vehicle.

Furthermore, reservoir 79 is connected to tank 21 for the urea solution including diethylene glycol dibutyl ether via a return line 82 in which a throttle valve 83 is situated.

The method implemented using the device according to FIG. 7 described above takes place in such a way that the solution including urea, diethylene glycol dibutyl ether and water stored in tank 21 is fed into reactor 42 under pressure by pump 41 via line 75 and is heated there to a temperature higher than 200° C. by heating apparatus 76. The heating causes the urea (NH₂)₂CO and the water H₂O of the solution to be converted into ammonia NH₃ and carbon dioxide CO₂. The solution and the decomposition product produced from the solution are present in reactor 42 under a pressure p₁, which is greater than pressure p₀ present in tank 21.

Downstream of reactor 42, the pressure of the decomposition product, which includes ammonia, carbon dioxide, water and the substance for transferring heat and for lowering the freezing point, is relieved using throttle valve 78 and is fed to reservoir 79. A binary phase system made up of a liquid and a gaseous phase is thus present in reservoir 79. The gaseous phase includes ammonia, carbon dioxide and water. With proper process control, the gaseous phase contains ammonia and carbon dioxide at a 2:1 ratio. The liquid phase contains water with the substance for transferring heat and for lowering the freezing point and a dissolved portion of ammonia and carbon dioxide. Gas pressure p₂ prevailing in reservoir 79 is lower than pressure p₁ prevailing in reactor 42; however, it is higher than pressure p₀ prevailing in tank 21. Pressure p₂ of the gaseous phase is adequate to overcome the exhaust gas pressure acting via metering pipe 81 and to be able to feed the gases directly into the exhaust system of the motor vehicle. The gaseous phase including ammonia, carbon dioxide and water is cooled on being removed from reservoir 79 so that the water contained in the gaseous phase condenses, as a result of which only ammonia and carbon dioxide in a gaseous phase are fed into the exhaust system. There, the ammonia reacts with the nitrogen oxides contained in the combustion gas of the internal combustion engine.

The liquid phase contained in reservoir 79 is returned to tank 21 via return line 82. The consumption of urea is made up for by the addition of urea into tank 21 via feed line 71.

What is claimed is:

1. A method for reducing nitrogen oxides of an exhaust gas, an exhaust gas of a motor vehicle in particular, an aqueous urea solution being fed to a reactor (22, 42, 61) and converted by thermal, catalytic or enzymatic treatment into a decomposition product including ammonia and carbon dioxide, and at least the ammonia is added to the exhaust gas, wherein the aqueous urea solution includes a substance for transferring heat and for lowering the freezing point.

2. The method as recited in claim 1, wherein the substance for transferring heat and for lowering the freezing point is selected from a group including diethylene glycol diethyl ether, diethylene glycol dibutyl ether and diethylene triamine.

3. The method as recited in claim 1 or 2, wherein the aqueous urea solution is a supersaturated solution and the urea and the water of the solution have a 1:1 molar ratio.

4. The method as recited in one of claims 1 through 3, wherein ammonia is added to the aqueous urea solution containing the substance for transferring heat and for lowering the freezing point.

5. The method as recited in one of claims 1 through 4, wherein the aqueous urea solution containing the substance for transferring heat and for lowering the freezing point is pumped into the reactor (22, 42, 61) under pressure.

6. The method as recited in one of claims 1 through 5, wherein the aqueous urea solution containing the substance for transferring heat and for lowering the freezing point in the reactor (42, 61) is heated to a temperature higher than at least approximately 180° C., preferably to a temperature of approximately 220° C.

7. The method as recited in claim 5 or 6, wherein the pressure of the decomposition product is relieved downstream of the reactor (42).

8. The method as recited in one of claims 1 through 4, wherein the decomposition product is compressed downstream of the reactor (22).

9. The method as recited in one of claims 1 through 5 or 7 or 8, wherein the aqueous urea solution containing the substance for transferring heat and for lowering the freezing point is heated in the reactor (22) to a temperature ranging between 80° C. and 150° C.

10. The method as recited in claim 9, wherein the isocyanic acid produced in the reactor (22) is broken down into carbon dioxide and ammonia in a hydrolytic catalytic converter.

11. The method as recited in one of claims 1 through 10, wherein a liquid phase of the decomposition product appearing downstream of the reactor (42) is returned to a tank (21) for the aqueous urea solution containing the substance for transferring heat and for lowering the freezing point.

12. The method as recited in claim 11, wherein the pressure of the liquid phase is relieved when it is returned.

13. The method as recited in one of claims 1 through 12, wherein the decomposition product is cooled downstream of the reactor (61).

14. The method as recited in one of claims 1 through 13, wherein the aqueous urea solution containing the substance for transferring heat and for lowering the freezing point is heated by the exhaust gas.

15. A device for implementing the method as recited in claim 1, including a tank (21) for an aqueous urea solution, a reactor (22, 42, 61) for preconditioning the aqueous urea solution and a valve (24, 52, 65, 80) for introducing a decomposition product containing ammonia produced by the reactor (22, 42, 61) into an exhaust system (62), wherein the aqueous urea solution contains a substance for transferring heat and for lowering the freezing point.

16. The device as recited in claim 15, wherein the reactor is designed as a helical pipe (61).

17. The device as recited in claim 15 or 16, wherein the reactor (61) is situated in the exhaust system (62).

18. The device as recited in one of claims 15 through 17, wherein a heat exchanger (64) for cooling the preconditioned aqueous urea solution is situated downstream of the reactor (61).

19. The device as recited in one of claims 15 through 18, wherein a pump (41) is situated upstream of the reactor (42, 61).

20. The device as recited in one of claims 15 through 19, wherein a pump (23) is situated downstream of the reactor (22).

21. The device as recited in claim 20, wherein a valve (51) is situated between the pump (41) and the reactor (42).

22. The device as recited in one of claims 15 through 21, wherein the valve for introducing the decomposition product containing ammonia is designed as a check valve (52).
